(19) United States
(12) Patent Application Publication
(10) Pub. No.: US 2026/0332689 A1
(43) Pub. Date: Oct. 22, 2026

(54) ELECTRIC HINGE APPARATUS AND ELECTRONIC DEVICE

(71) Applicant: AAC Microtech (Changzhou) Co., Ltd., Changzhou City (CN)

(72) Inventors: Zhengmin Benjamin Pan, L.A., CA (US); Sensen Yang, Changzhou (CN); Junsheng Wang, Changzhou (CN); Tianyu Xie, Changzhou (CN); Wei Song, Changzhou (CN)

(21) Appl. No.: 19/342,717

(22) Filed: Sep. 29, 2025

Related U.S. Application Data
(63) Continuation of application No. PCT/CN2025/089641, filed on Apr. 17, 2025.

(51) Int. Cl. H04M 1/02

(52) U.S. Cl. CPC H04M 1/0214

(57) ABSTRACT

Provided are an electric hinge apparatus and an electronic device. The electric hinge apparatus includes a base, a first drive mechanism including a first motor and a first reduction gearbox, a second drive mechanism including a second motor and a second reduction gearbox, a first and second gear transmission mechanisms, a first hinge mechanism, and a deformation monitoring plate. The deformation monitoring piece is configured to monitor the fold region of the screen when there is a crease. The resistance value of the deformation monitoring piece changes if the crease exists. When the resistance value is greater than a predetermined threshold resistance, the input voltages of the first and second motors are controlled as a direct current voltage, causing them to generate heat to warm the fold region. The electric hinge apparatus can achieve synchronous opening and closing on both sides, thereby reducing creases and enhancing user experience.

### CROSS-REFERENCE TO RELATED APPLICATIONS

This application is a continuation of International Application No. PCT/CN2025/089641, filed Apr. 17, 2025, the entire contents of which are incorporated herein by reference.

### TECHNICAL FIELD

The present application relates to the technical field of electronic devices, in particular to an electric hinge apparatus and an electronic device.

### BACKGROUND

The rise of the mobile internet era has witnessed a continuous increase in the number of smart mobile devices. Among many mobile devices, foldable electronic devices, such as foldable smartphones, foldable tablets, and laptops, have gained significant consumer preference due to their portability and large display advantages. These foldable electronic devices achieve their folding functionality through specialized hinge mechanisms. Typically, they feature multiple operational states including folded, unfolded (flat), and semi-folded (hovering) configurations. To maintain stable positioning across these different folding states, the hinge mechanisms are designed with intentionally engineered rotational resistance and locking forces, such as frictional resistance, mechanical locking force, and magnetic attraction force.

In the related art, the electronic device generally includes a first body, a second body, and an opening/closing structure for connecting the first body and the second body. By incorporating a motor within the hinge mechanism, automated hinge operation is achieved through motorized actuation, driving the adjustment of the opening and closing of the first body and the second body. This technological approach significantly enhances the folding/unfolding user experience of foldable electronic devices.

However, in such electronic devices, significant rotational backlash exists between the first and second bodies, requiring manual folding with low automation, resulting in user inconvenience and physical effort. During initial usage, the fold crease remains relatively flat and is almost imperceptible; however, due to the material's inherent softness, mechanical stress accumulates on the screen surface. After prolonged use, the crease becomes significantly pronounced, resulting in a visibly depressed trace along the central fold that markedly compromises user experience.

Therefore, it is necessary to provide a new electric hinge apparatus to solve the above technical problems.

### SUMMARY

An object of the present application is to provide an electric hinge apparatus with dual output shafts coupled by a gear set, enabling synchronized opening and closing motion on both sides, thereby reducing creases and enhancing the user experience.

To achieve the above purpose, the first aspect of the present application provides an electric hinge apparatus for adjusting the automatic opening and closing of a screen, wherein the screen includes a fold region, and the electric hinge apparatus includes:
a base;
a first drive mechanism, including:
   a first motor fixed to the base; and
   a first reduction gearbox fixed to the base and connected to the first motor for power transmission;
a second drive mechanism arranged in parallel with the first drive mechanism, and including:
a second motor fixed to the base; and
a second reduction gearbox fixed to the base and connected to the second motor for power transmission; the fold region is located on a side of the first motor and a side of the second motor that are away from the base;
a first gear transmission mechanism connected to an output end of the first reduction gearbox of the first drive mechanism;
a second gear transmission mechanism connected to an output end of the second reduction gearbox of the second drive mechanism, wherein the first gear transmission mechanism and the second gear transmission mechanism are coupled to form synchronous transmission;
a first hinge mechanism mounted on the base, wherein the first gear transmission mechanism and the second gear transmission mechanism are connected to the first hinge mechanism for driving the first hinge mechanism to achieve synchronous folding or unfolding; and
a deformation monitoring plate fixedly attached to a side of the fold region adjacent to the first motor and the second motor, wherein when the screen is in an unfolded state, the deformation monitoring plate is configured to monitor whether a crease exists in the fold region of the screen; a resistance value of the deformation monitoring plate changes if the crease exists in the fold region; when the resistance value of the deformation monitoring plate exceeds a predetermined threshold resistance, an input voltage to the first motor and an input voltage to the second motor are controlled to be a DC voltage, causing the first motor and the second motor to generate heat to warm the fold region of the screen.

As an improvement, the electric hinge apparatus further includes a bracket fixed to the base, wherein the first reduction gearbox and the second reduction gearbox are fixed to the bracket.

As an improvement, the first gear transmission mechanism includes a first gear, a second gear meshed with the first gear, a third gear coaxially driven with the second gear, a fourth gear meshed with the third gear, and a first output shaft fixed to an end of the fourth gear away from the first motor and connected to the first hinge mechanism;
the second gear transmission mechanism includes a fifth gear, a sixth gear meshed with the fifth gear, a seventh gear coaxially driven with the sixth gear, an eighth gear meshed with the seventh gear, and a second output shaft fixed to an end of the eighth gear away from the first motor and connected to the first hinge mechanism, wherein the second gear is coupled to the sixth gear.

As an improvement, a diameter of the first gear is equal to a diameter of the third gear, a diameter of the second gear is equal to a diameter of the fourth gear, and the diameter of the second gear is greater than the diameter of the first gear;
the diameter of the first gear is equal to a diameter of the fifth gear, and the diameter of the second gear is equal to a diameter of the sixth gear; the diameter of the third gear is equal to a diameter of the seventh gear, and the diameter of the fourth gear is equal to a diameter of the eighth gear.

As an improvement, the electric hinge apparatus further includes a fixing plate, which is fixed to the base and disposed between the first gear and the third gear and between the fifth gear and the seventh gear; the first gear to the eighth gear are respectively rotatably connected to the fixing plate.

As an improvement, the electric hinge apparatus further includes a fixing member having an arc-shaped surface, which is fixed to the base; wherein the fixing plate is inserted and fixed to the fixing member, and the first gear, the second gear, the fifth gear, and the sixth gear are respectively rotatably disposed on the arc-shaped surface.

As an improvement, the first reduction gearbox and the second reduction gearbox are both three-stage planetary reduction gearboxes.

As an improvement, the first hinge mechanism includes:
a first slider and a second slider, wherein the first slider and the second slider are arranged oppositely, and an end of the first slider adjacent to the second slider and an end of the second slider adjacent to the first slider are respectively connected to the first gear transmission mechanism and the second gear transmission mechanism for power transmission; the first slider is fixedly sleeved around the first output shaft, and the second slider is fixedly sleeved around the second output shaft;
a first fixing block, which is fixed to the base and located on a side of the first slider away from the first drive mechanism and a side of the second slider away from the second drive mechanism; an end of the first output shaft is rotatably connected to the first fixing block, and an end of the second output shaft is rotatably connected to the first fixing block;
a first swing arm and a second swing arm that are arranged side by side, wherein an end of the first swing arm and an end of the second swing arm that are close to each other are both rotatably connected to the first fixing block; and
a first connecting member and a second connecting member that are located on opposite sides of the first fixing block, respectively, wherein an end of the first slider away from the second slider is slidably connected to the first connecting member, and an end of the first swing arm away from the first fixing block is rotatably connected to the first connecting member; an end of the second slider away from the first slider is slidably connected to the second connecting member, and an end of the second swing arm away from the first fixing block is rotatably connected to the second connecting member.

As an improvement, the first connecting member includes a first connecting body, a first T-shaped groove formed by the first connecting body extending from a side adjacent to the first fixing block to a side away from the first fixing block, and a first arc-shaped groove; the end of the first slider away from the second slider is disposed within the first T-shaped groove and forms a sliding connection, and the end of the first swing arm away from the second swing arm is disposed within the first arc-shaped groove and forms a rotational connection;
the second connecting member includes a second connecting body, a second T-shaped groove formed by the second connecting body extending from a side adjacent to the first fixing block to a side away from the first fixing block, and a second arc-shaped groove; the end of the second slider away from the first slider is disposed within the second T-shaped groove to form a sliding connection, and an end of the second swing arm away from the first swing arm is disposed within the second arc-shaped groove to form a rotational connection.

As an improvement, the electric hinge apparatus further includes a second hinge mechanism fixed to the base and located at an end of the first drive mechanism and an end of the second drive mechanism that are away from the first hinge mechanism, wherein the second hinge mechanism is arranged opposite the first hinge mechanism, and the second hinge mechanism has the same structure as the first hinge mechanism.

As an improvement, the electric hinge apparatus further includes a conductive member fixed to the base and located between the first drive mechanism and the second drive mechanism, wherein the conductive member is electrically connected to the first drive mechanism, the second drive mechanism, and the deformation monitoring plate.

In the second aspect, the present application provides an electronic device including:
a first body;
a second body;
a control switch;
a power module;
a drive module; and
the aforementioned electric hinge apparatus;
wherein the power supply module is fixed within the first body and/or the second body, and the power supply module is configured to supply power to the drive module and the deformation monitoring plate; the screen is covered and fixed on a side of the first body, a side of the electric hinge apparatus, and a side of the second body that are away from the base; the control switch controls the drive module to operate; the first body and the second body are located on opposite sides of the base, respectively, and the first body and the second body are fixed on opposite sides of the first hinge mechanism, respectively; the drive module is electrically connected to the first drive mechanism and the second drive mechanism, to control the first drive mechanism and the second drive mechanism to operate.

As an improvement, the electronic device further includes a first support plate, a second support plate, and a third support plate that are arranged in parallel, wherein the first support plate, the second support plate, and the third support plate are mounted on the first hinge mechanism, and they are all located below the screen; the second support plate is located below the fold region; the first support plate and the third support plate fold or unfold synchronously with the first hinge mechanism, and the deformation monitoring plate is located between the fold region and the second support plate.

As an improvement, a side of the second support plate adjacent to the screen is recessed toward a side away from the screen to form a clearance region, and the deformation monitoring plate is located within the clearance region.

Compared with the related art, in the electric hinge apparatus of the present application, the first drive mechanism and the second drive mechanism are relatively mounted on the base, and the first drive mechanism includes a first motor fixed to the base and a first reduction gearbox fixed to the base and connected to the first motor. The second drive mechanism is arranged side by side with the first drive mechanism, and the second drive mechanism includes a second motor fixed to the base and a second reduction gearbox fixed to the base and connected to the second motor. The first gear transmission mechanism and the second gear transmission mechanism are respectively connected to an output end of the first reduction gearbox of the first drive mechanism and an output end of the second reduction gearbox of the second drive mechanism for power transmission, and the first gear transmission mechanism and the second gear transmission mechanism are coupled together to form synchronous transmission. This multi-stage transmission method, which combines reduction gearboxes and gear transmission mechanisms, provides sufficient torque for the foldable smartphone. While the dual motors drive in parallel, the dual output shafts are coupled via a gear set, enabling synchronized opening and closing on both sides, thereby delivering an intelligent and technologically advanced user experience. Additionally, by connecting the first gear transmission mechanism and the second gear transmission mechanism to the first hinge mechanism for power transmission, the first hinge mechanism is driven to achieve automatic synchronized folding or unfolding. When the screen is in the unfolded state, the deformation monitoring plate monitors whether a crease exists in the fold region of the screen. If the crease is detected in the fold region, the resistance value of the deformation monitoring plate changes. When the resistance value of the deformation monitoring plate exceeds the preset threshold resistance, the input voltage to the first motor and second motor is set to a DC voltage, causing the first motor and second motor to generate heat and warm the fold region of the screen. This induces minor changes in the molecular structure of the screen material at that location, thereby reducing or eliminating the crease and enhancing the user experience.

### BRIEF DESCRIPTION OF THE DRAWINGS

In order to more clearly illustrate the technical solutions in the embodiments of the present application, the accompanying drawings that need to be used in the description of the embodiments will be briefly introduced as follows. Obviously, the accompanying drawings in the following description are only some of the embodiments of the present application. For the person of ordinary skill in the field, other accompanying drawings may be obtained based on these drawings without putting forth any creative labor.

FIG. 1 shows a schematic structural diagram of an electric hinge apparatus according to Embodiment one of the present application.

FIG. 2 shows a schematic exploded view of the electric hinge apparatus according to Embodiment one of the present application.

FIG. 3 shows an exploded view of a first hinge mechanism of FIG. 2.

FIG. 4 is a cross-sectional view taken along line A-A of FIG. 1.

FIG. 5 is a cross-sectional view taken along line B-B of FIG. 1.

FIG. 6 shows a schematic structural diagram of a first connecting member of the electric hinge apparatus according to Embodiment one of the present application.

FIG. 7 shows a schematic structural diagram of a second connecting member of the electric hinge apparatus according to Embodiment one of the present application.

FIG. 8 shows a schematic diagram of a three-dimensional structure of the electronic device according to Embodiment two of the present application.

FIG. 9 is a cross-sectional view of line C-C of FIG. 8.

FIG. 10 is an exploded view of the electronic device provided in embodiment two of the present application.

In the figures, 100, electric hinge apparatus; 1, base; 2, first drive mechanism; 21, first motor; 22, first reduction gearbox; 3, second drive mechanism; 31, second motor; 32, second reduction gearbox; 4, first gear transmission mechanism; 41, first gear; 42, second gear; 43, third gear; 44, fourth gear; 45, first output shaft; 5, second gear transmission mechanism; 51, fifth gear; 52, sixth gear; 53, seventh gear; 54, eighth gear; 55, second output shaft; 6, first hinge mechanism; 61, first slider; 62, second slider; 63, first fixing block; 64, first swing arm; 65, second swing arm; 66, first connecting member; 661, first connecting body; 662, first T-shaped groove; 663, first arc-shaped groove; 67, second connecting member; 671, second connecting body; 672, second T-shaped groove; 673, second arc-shaped groove; 7, bracket; 8, fixing member; 81, arc-shaped surface; 9, fixing piece; 10, second hinge mechanism; 11, conductive member; 12, deformation monitoring piece;

200, electronic device; 201, first body; 202, second body; 203, screen; 2031, fold region; 204, drive module; 205, power module; 206, first support plate; 207, second support plate; 2071, clearance region; 208, third support plate; and 209, control switch.

### DETAILED DESCRIPTION OF THE EMBODIMENTS

The technical solutions of the embodiments of the present application will be described in detail below with reference to the accompanying drawings. It should be noted that the described embodiments are merely some examples of the present application and not all possible embodiments. All other embodiments obtained by ordinary technicians in the field without making creative contributions based on the embodiments of the present application are within the scope of protection of the present application.

### Embodiment One

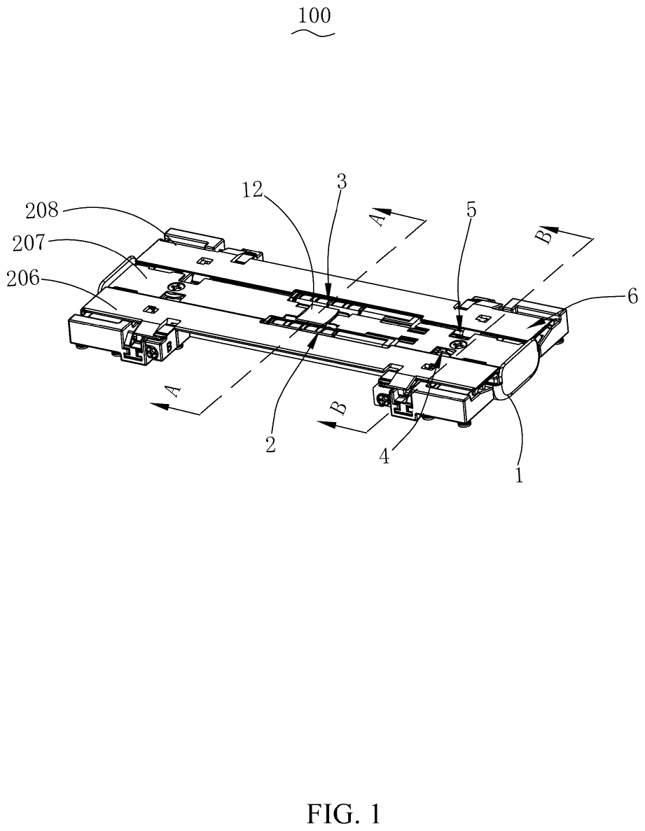

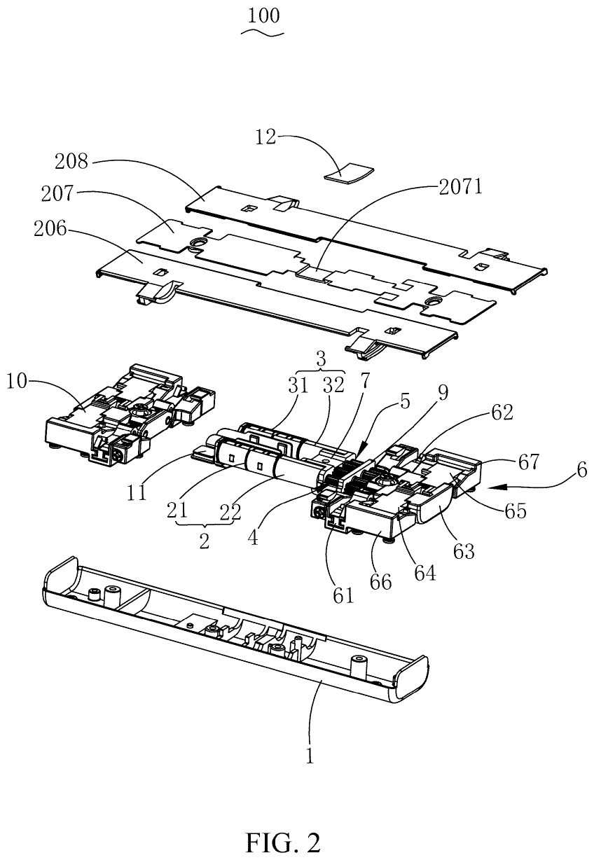

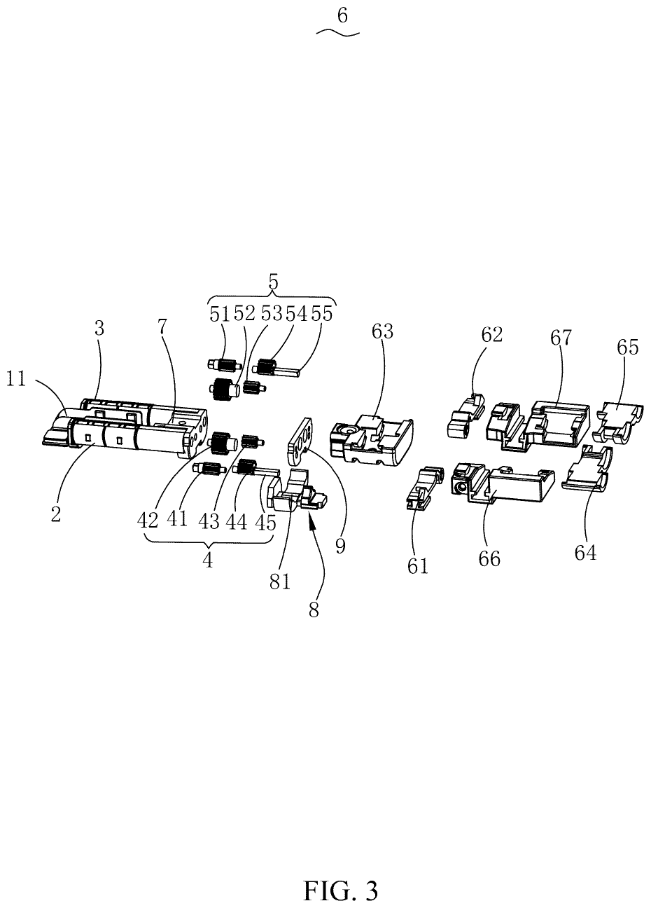

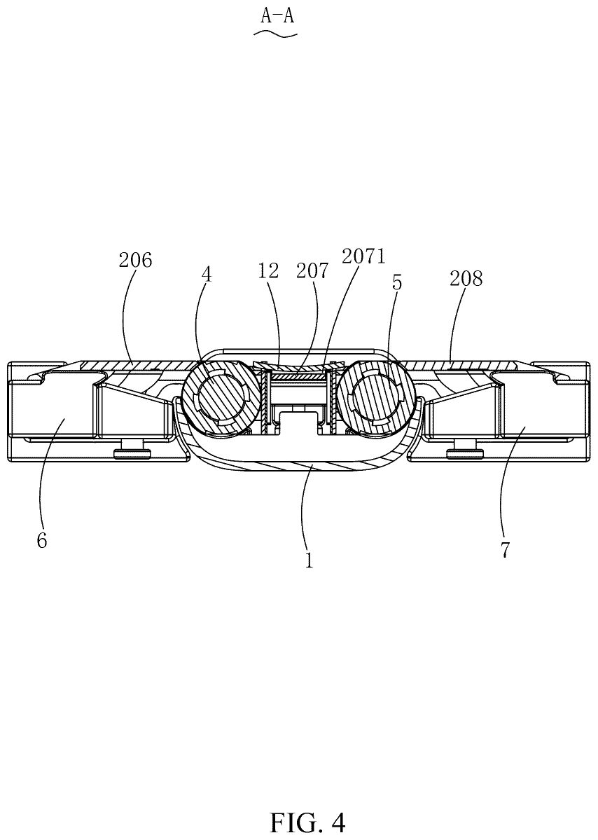

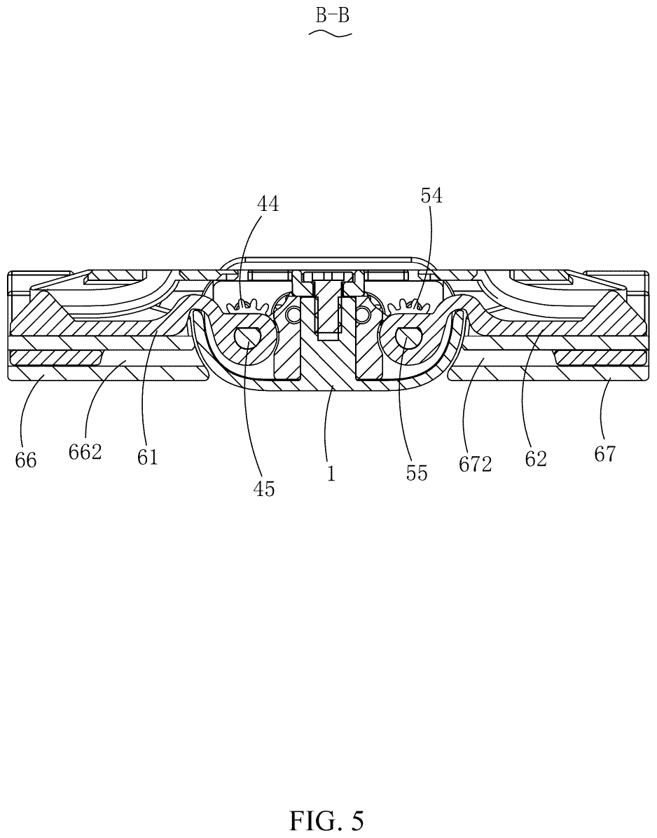

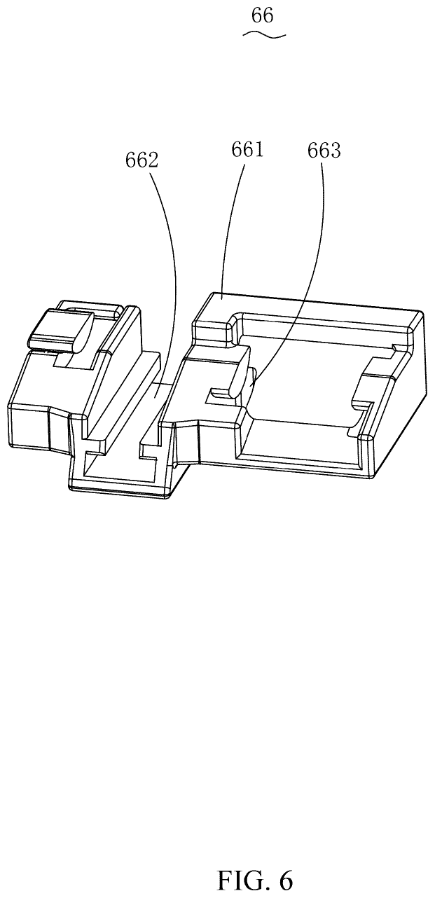

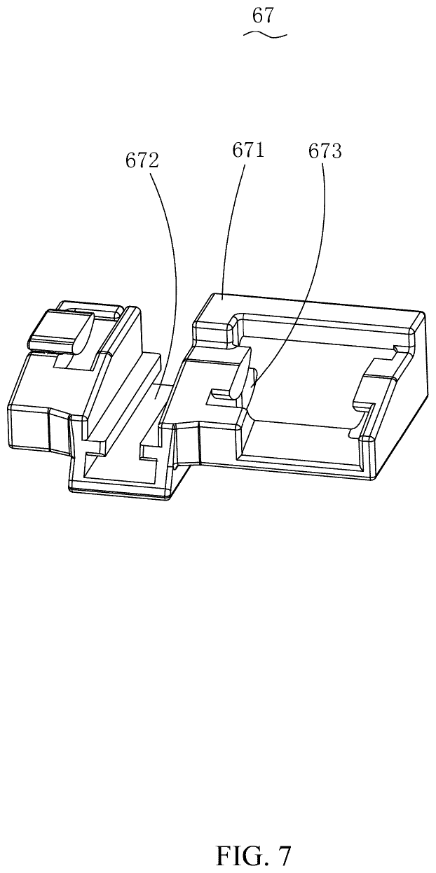

As shown in FIGS. 1-7, the present application provides an electric hinge apparatus 100 for adjusting the automatic opening and closing of a screen 203. The screen 203 includes a fold region 2031. The electric hinge apparatus 100 includes: a base 1, a first drive mechanism 2, a second drive mechanism 3, a first gear transmission mechanism 41, a second gear transmission mechanism 5, a first hinge mechanism 6, and a deformation monitoring plate 12.

The base 1 is configured to mount the first drive mechanism 2, the second drive mechanism 3, the first gear transmission mechanism 41, the second gear transmission mechanism 5, and the first hinge mechanism 6.

The first drive mechanism 2 is configured to drive the first gear transmission mechanism 41 to move and drive the first hinge mechanism 6 to fold. The first drive mechanism 2 includes a first motor 21 fixed to the base 1 and a first reduction gearbox 22 fixed to the base 1 and connected to the first motor 21 for power transmission. The first electric drive drives the first reduction gearbox 22 for speed reduction, thereby achieving a higher transmission ratio output torque, and providing sufficient opening and closing force for the first hinge mechanism 6.

The second drive mechanism 3 is configured to drive the first gear transmission mechanism 41 to move and drive the first hinge mechanism 6 to fold. The first drive mechanism 2 and the second drive mechanism 3 are arranged side by side. The second drive mechanism 3 includes a second motor 31 fixed to the base 1 and a second reduction gearbox 32 fixed to the base 1 and connected to the second motor 31. The fold region 2031 is located on a side of the first motor 21 and a side of the second motor 31 that are away from the base 1. By using the second electric drive to drive the second reduction gearbox 32 for speed reduction, a higher gear ratio output torque is achieved, thereby providing sufficient opening and closing force for the first hinge mechanism 6.

In this embodiment, the first reduction gearbox 22 and the second reduction gearbox 32 are both three-stage planetary reduction gearboxes.

The first gear transmission mechanism 41 is connected to an output end of the first reduction gearbox 22 of the first drive mechanism 2 for power transmission, and the second gear transmission mechanism 5 is connected to an output end of the second reduction gearbox 32 of the second drive mechanism 3 for power transmission. The first gear transmission mechanism 41 and the second gear transmission mechanism 5 are coupled to form a synchronous transmission.

The first hinge mechanism 6 is mounted on the base 1, and the first gear transmission mechanism 41 and the second gear transmission mechanism 5 are connected to the first hinge mechanism 6 for power transmission, for driving the first hinge mechanism 6 to achieve automatic synchronous folding or unfolding. A microcontroller is adopted to drive the first motor 21 and the second motor 31 with square waves, with the first motor 21 and the second motor 31 rotating in opposite directions. Through the first gearbox 4 and the second gearbox 42, which are respectively connected to the first gear transmission mechanism 41 and the second gear transmission mechanism 5, the system achieves the required torque for foldable mobile phones by increasing the transmission ratio, thereby enabling synchronous electric opening and closing of both hinges and providing an intelligent and technologically advanced user experience.

In this embodiment, the first hinge mechanism 6 includes a first slider 61 and a second slider 62. The first slider 61 and the second slider 62 are arranged oppositely, and the end of the first slider 61 adjacent to the second slider 62 and the end of the second slider 62 adjacent to the first slider 61 are respectively connected to the first gear transmission mechanism 41 and the second gear transmission mechanism 5 for power transmission. The first slider 61 is fixedly sleeved around the first output shaft 45, and the second slider 62 is fixedly sleeved around the second output shaft 55.

The first hinge mechanism 6 further includes a first fixing block 63, which is fixed to the base 1 and located on the side of the first slider 61 away from the first drive mechanism 2 and the side of the second slider 62 away from the second drive mechanism 3. The end of the first output shaft 45 is rotatably connected to the first fixing block 63, and the end of the second output shaft 55 is rotatably connected to the first fixing block 63.

The first hinge mechanism 6 further includes a first swing arm 64 and a second swing arm 65 that are arranged side by side. The end of the first swing arm 64 and the end of the second swing arm 65 that are adjacent to each other are rotatably connected to the first fixing block 63.

The first hinge mechanism 6 further includes a first connecting member 66 and a second connecting member 67 that are located on opposite sides of the first fixing block 63, respectively. The end of the first slide block 61 away from the second slide block 62 is slidably connected to the first connecting member 66, and the end of the first swing arm 64 away from the first fixing block 63 is rotatably connected to the first connecting member 66. The end of the second slide block 62 away from the first slide block 61 is slidably connected to the second connecting member 67, and the end of the second swing arm 65 away from the first fixing block 63 is rotatably connected to the second connecting member 67.

Specifically, the first drive mechanism 2 and the second drive mechanism 3 drive the first gear transmission mechanism 41 and the second gear transmission mechanism 5 to move, respectively. The first gear transmission mechanism 41 and the second gear transmission mechanism 5 drive the first slider 61 and the second slider 62 to flip, respectively. The first connecting member 66 is connected to the first swing arm 64 and the first slider 61, and the second connecting member 67 is connected to the second slider 62 and the second swing arm 65. By synchronizing the movement of the first drive mechanism 2 and the second drive mechanism 3, the flipping angles of the first slider 61 and the second slider 62 are made consistent. This allows the first slider 61 and the second slider 62 to slide along the first connecting member 66 and the second connecting member 67, respectively, thereby driving the first swing arm 64 and the second swing arm 65 to swing, achieving the effect of synchronized opening and closing. While the first drive mechanism 2 and the second drive mechanism 3 are driven in parallel, the dual output shafts are coupled via a gear set, enabling synchronized opening and closing on both sides, thereby meeting the user experience requirements for intelligence and technological sophistication.

Additionally, the first drive mechanism 2, the second drive mechanism 3, the first gear transmission mechanism 41, the second gear transmission mechanism 5, and the first hinge mechanism 6 are all mounted on the base 1. This design achieves a high reduction ratio within the limited space of the base 1, ensuring the required torque and electric drive force for hinge opening and closing. The system has high integration, occupies minimal space, and offers broader application scenarios.

In this embodiment, the electric hinge apparatus 100 further includes a second hinge mechanism 10 fixed to the base 1 and located at the end of the first drive mechanism 2 and the end of the second drive mechanism 3 that are away from the first hinge mechanism 6. The second hinge mechanism 10 is arranged opposite the first hinge mechanism 6, and the second hinge mechanism 10 has the same structure as the first hinge mechanism 6. By arranging the first hinge mechanism 6 and the second hinge mechanism 10 at opposite ends of the base 1 and having the same structure, the overall stability of the electric hinge apparatus 100 is enhanced.

The deformation monitoring plate 12 is fixedly attached to the side of the fold region 2031 adjacent to the first motor 21 and the second motor 31. When the screen 203 is in an unfolded state, the deformation monitoring plate 12 is configured to monitor whether a crease exists in the fold region 2031 of the screen 203. If the crease exists in the fold region 2031, the resistance value of the deformation monitoring plate 12 changes. When the resistance value of the deformation monitoring strip 12 exceeds a predetermined threshold resistance value, the input voltage to the first motor 21 and the input voltage to the second motor 31 are controlled to be a DC voltage, causing the first motor 21 and the second motor 31 to generate heat to warm the fold region 2031 of the screen 203. In an embodiment, the deformation monitoring plate 12 may be a deformation monitoring sensor, etc., which is configured to monitor crease data of the fold region 2031 of the screen 203.

When detecting deformation, the deformation monitoring plate 12 performs a DC drive. In this circumstance, the two motors act as two resistors, generating heat to warm and soften the screen 203 at the crease where the motors are located, helping the screen 203 release stress and promoting the rearrangement of molecules in the material of the screen 203, thereby reducing the prominence of the crease. Specifically, when the phone is in the unfolded state, the screen 203 is also in a flat state. The deformation monitoring plate 12 monitors the deformation of the screen 203 at the center of the foldable screen. If there is a crease, the resistance value of the deformation monitoring plate 12 changes. When the resistance exceeds a certain threshold, the input voltage to the first motor 21 and the input voltage to the second motor 31 are controlled to be direct current, causing the first motor 21 and the second motor 31 to generate heat to warm the screen 203 in the fold region. This causes the molecular structure of the screen 203 material in that region to undergo minor changes and promotes the rearrangement of molecules within the material of the screen 203, reducing the memory effect of the material and thereby mitigating or eliminating the crease.

After the first motor 21 and the second motor 31 have heated the screen 203, when the deformation monitoring plate 12 detects that there are no creases in the fold region 2031 of the screen 203, the feedback from the deformation monitoring plate is transmitted to the corresponding microcontroller, which then controls the first motor 21 and the second motor 31 to stop heating.

In this embodiment, the first motor 21 and the second motor 31 drive the screen to achieve bilateral synchronous electric opening and closing. This design enables a high reduction ratio in the composite reduction transmission system based on a dual-motor design within a compact space, ensuring the required torque and electric driving force for hinge opening and closing. The system has high integration, occupies minimal space, and has a wide range of application scenarios. Additionally, it can eliminate creases on the screen 203 of a foldable smartphone caused by long-term use through the deformation monitoring plates 12 and the self-heating of the motor, offering advantages such as simple installation, minimal space requirements, and suitability for long-term monitoring.

In this embodiment, the electric hinge apparatus 100 further includes a bracket 7, which is fixed to the base 1. The first reduction gearbox 22 and the second reduction gearbox 32 are fixed to the bracket 7. By fixedly connecting the bracket 7 to the base 1, the first reduction gearbox 22 and the second reduction gearbox 32 are firmly fixed, ensuring stable operation without vibration when the first motor 21 and the second motor 31 drive the first reduction gearbox 22 and the second reduction gearbox 32, respectively.

In this embodiment, the first gear transmission mechanism 41 includes a first gear 4, a second gear 42 meshed with the first gear 4, a third gear 43 coaxially driven with the second gear 42, a fourth gear 44 meshed with the third gear 43, and a first output shaft 45 fixed to the end of the fourth gear 44 away from the first motor 21. The first output shaft 45 is connected to the first hinge mechanism 6.

The second gear transmission mechanism 5 includes a fifth gear 51, a sixth gear 52 meshing with the fifth gear 51, a seventh gear 53 coaxially driven with the sixth gear 52, an eighth gear 54 meshed with the seventh gear 53, and a second output shaft 55 fixed to the end of the eighth gear 54 away from the first motor 21. The second output shaft 55 is connected to the first hinge mechanism 6, and the second gear 42 is coupled to the sixth gear 52.

In this embodiment, the diameter of the first gear 4 is equal to the diameter of the third gear 43, the diameter of the second gear 42 is equal to the diameter of the fourth gear 44, and the diameter of the second gear 42 is greater than the diameter of the first gear 4.

The diameter of the first gear 4 is equal to the diameter of the fifth gear 51, and the diameter of the second gear 42 is equal to the diameter of the sixth gear 52. The diameter of the third gear 43 is equal to the diameter of the seventh gear 53, and the diameter of the fourth gear 44 is equal to the diameter of the eighth gear 54.

Specifically, the first motor 21 drives the first reduction gearbox 22 to reduce speed, and the output end of the first reduction gearbox 22 drives the first gear 4 to rotate. The first gear 4 drives the second gear 42 and the third gear 43 to rotate coaxially, and the third gear 43 drives the fourth gear 44 to rotate, thereby causing the first output shaft 45 to drive the first slider 61 to slide on the first connecting member 66, and causing the first connecting member 66 to swing while driving the first swing arm 64 to swing. The second motor 31 drives the second reduction gearbox 32 to reduce speed, and the output end of the second reduction gearbox 32 drives the fifth gear 51 to rotate. The fifth gear 51 drives the sixth gear 52 and the seventh gear 53 to rotate coaxially, and the seventh gear 53 drives the eighth gear 54 to rotate, thereby causing the second output shaft 55 to drive the second slider 62 to slide on the second connecting member 67, and causing the second connecting member 67 to swing while driving the second swing arm 65 to swing. By coupling the second gear 42 with the sixth gear 52, a dual motor parallel drive is achieved. The dual output shafts are coupled via a gear set, enabling the first swing arm 64 and the second swing arm 65 on both sides to open and close synchronously, ensuring a smooth opening and closing process with consistent speed and duration on both sides, thereby providing an intelligent and technologically advanced user experience.

In this embodiment, the transmission assemblies of both the first gear 4 and the second gear 42 are two-stage parallel gear sets. By mounting the aforementioned components on the base 1, a high-transmission-ratio torque output structure is achieved in a compact space, combining dual motor drive with a three-stage planetary reduction gearbox and a two-stage parallel gear set, providing sufficient opening and closing force for the hinge system.

In this embodiment, the electric hinge apparatus 100 further includes a fixing plate 9, which is fixed to the base 1. The fixing plate 9 is disposed between the first gear 4 and the third gear 43, as well as between the fifth gear 51 and the seventh gear 53. The first gear 4 to the eighth gear 54 are respectively rotatably connected to the fixing plate 9. The fixing plate 9 is configured to support the first gear 4 to the eighth gear 54, ensuring that the opening and closing process is stable and power transmission is smooth during the driving process.

In this embodiment, the electric hinge apparatus 100 further includes a fixing member 8, which has an arc-shaped surface 81. The fixing member 8 is fixed to the base 1, and the fixing plate 9 is inserted and fixed to the fixing member 8. The first gear 41, the second gear 42, the fifth gear 51, and the sixth gear 52 are respectively rotatably mounted on the arc-shaped surface 81. By adopting a coupled transmission design for the aforementioned multiple gears, the fixing member 8 and the base 1 are used to fix and position the parallel gear sets. The coupling of the two output gear sets ensures consistency in the opening and closing speed and duration of both sides of the swing arms, achieving synchronized opening and closing of the dual swing arms and optimizing the user experience.

In this embodiment, the first connecting member 66 includes a first connecting body 661, a first T-shaped groove 662 formed by the first connecting body 661 extending from a side adjacent to the first fixing block 63 to a side away from the first fixing block 63, and a first arc-shaped groove 663. The end of the first slider 61 away from the second slider 62 is disposed within the first T-shaped groove 662 to form a sliding connection, and the end of the first swing arm 64 away from the second swing arm 65 is disposed within the first arc-shaped groove 663 to form a rotational connection. When the first slider 61 is driven by the first motor 21 to flip, it drives the first connecting body 661 to flip and move upward, causing the first swing arm 64 to slide in the first arc-shaped groove 663. Simultaneously, the first connecting body 661 swings with the movement of the first slider 61, thereby driving the first swing arm 64 to swing, achieving the automatic folding or opening function.

The second connecting member 67 includes a second connecting body 671, a second T-shaped groove 672 formed by the second connecting body 671 extending from the side adjacent to the first fixing block 63 to the side away from the first fixing block 63, and a second arc-shaped groove 673. The end of the second slider 62 away from the first slider 61 is disposed within the second T-shaped groove 672 to form a sliding connection, while the end of the second swing arm 65 away from the first swing arm 64 is disposed within the second arc-shaped groove 673 to form a rotational connection. When the second slider 62 is driven by the second motor 31 to flip, it drives the second connecting body 671 to flip and move upward, causing the second swing arm 65 to slide in the second arc-shaped groove 673. Simultaneously, the second connecting body 671 swings with the movement of the second slider 62, thereby driving the second swing arm 65 to swing, achieving the automatic folding or opening function.

In this embodiment, the electric hinge apparatus 100 further includes a conductive member 11, which is fixed to the base 1 and located between the first drive mechanism 2 and the second drive mechanism 3. The conductive member 11 is electrically connected to the first drive mechanism 2, the second drive mechanism 3, and the deformation monitoring plate 12.

### Embodiment Two

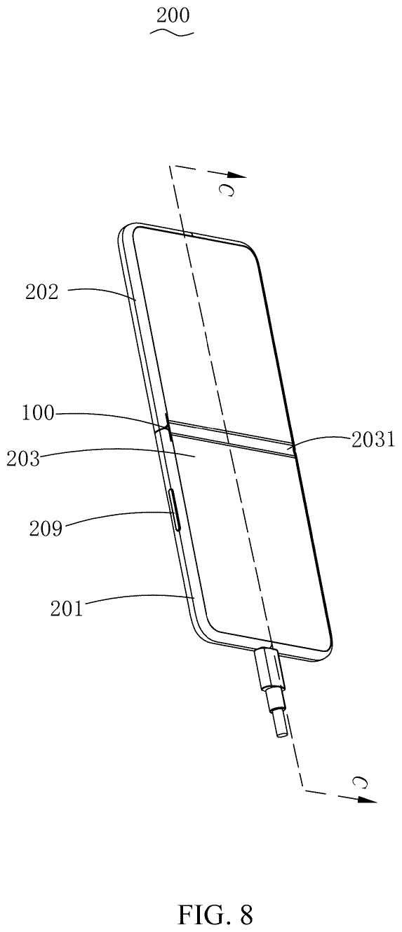

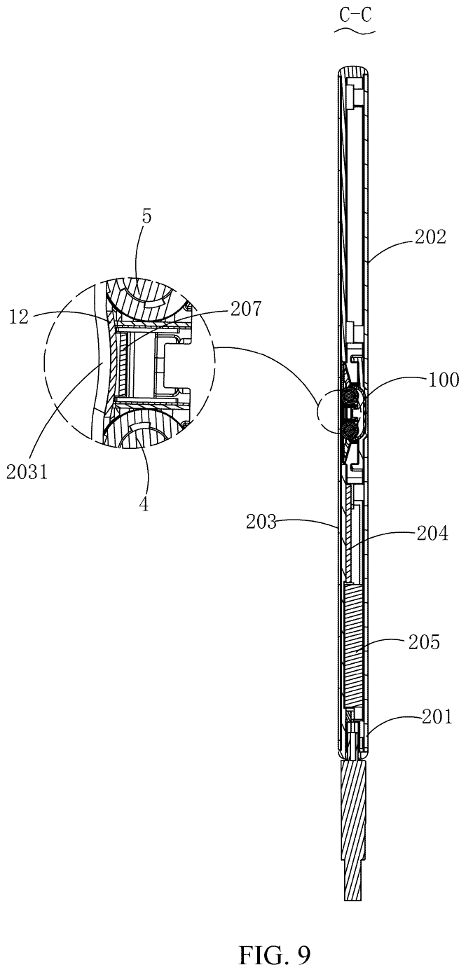

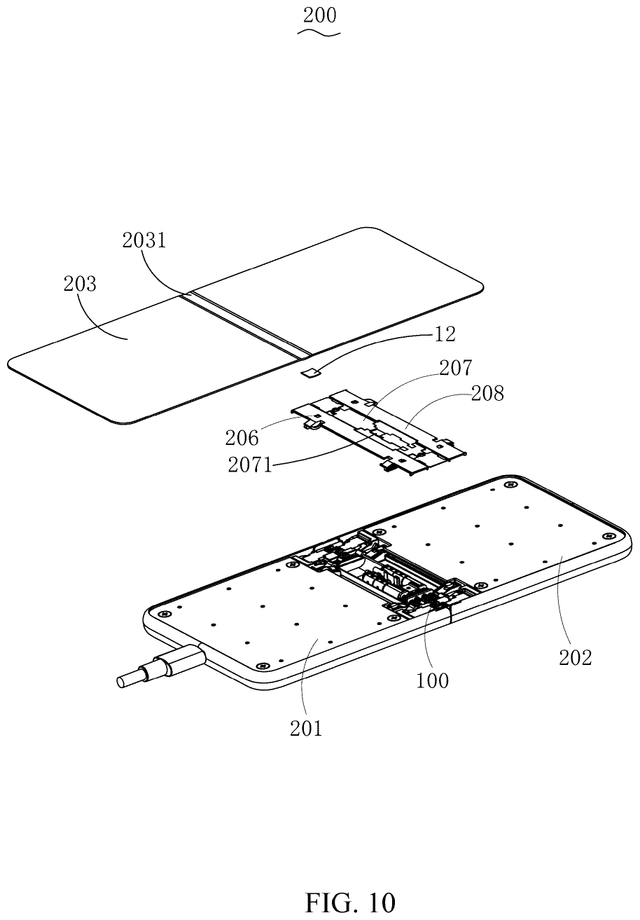

As shown in FIGS. 1-10, the present application provides an electronic device 200, including a first body 201, a second body 202, a control switch 209, a power module 205, a drive module 204, and the aforementioned electric hinge apparatus 100. The power supply module 205 is fixed within the first body 201 and/or the second body 202, and the power supply module 205 is configured to supply power to the drive module 204 and the deformation monitoring plate 12. The screen 203 is covered and mounted on the first body 201, the electric hinge apparatus 100, and the second body 202 on the side away from the base 1. The control switch 209 controls the operation of the drive module 204. The first body 201 and the second body 202 are located on opposite sides of the base 1, respectively, and the first body 201 and the second body 202 are fixed on opposite sides of the first hinge mechanism 6, respectively. The first body 201 is fixed to the side of the first connecting member 66 away from the first slider 61, and the second body 202 is fixed to the side of the second connecting member 67 away from the second slider 62. The drive module 204 is electrically connected to the first drive mechanism 2 and the second drive mechanism 3, to control the first drive mechanism 2 and the second drive mechanism 3 to operate. In an embodiment, the power supply module 205 is a lithium battery that can store electrical energy and supply power to the drive module 204, the first motor 21, the second motor 31, and other components.

The first body 201 and the second body 202 are configured to mount the drive module 204 and the power supply module 205. The screen 203 is stacked on the upper surface of the first body 201 and the upper surface of the second body 202.

Specifically, the power supply module 205 supplies power to the drive module 204 and the deformation monitoring plate 12. The first motor 21 and the second motor 31, which serve as the output ends, are connected to the drive module 204 through the conductive member 11, ensuring that the folding mechanism does not damage the circuit. The first motor 21 and the second motor 31 utilize a dual reduction mechanism to transmit torque, driving the first swing arm 64 and the second swing arm 65 to perform opening and closing actions. The first swing arm 64 and the second swing arm 65 respectively drive the first main body 201 and the second main body 202 to achieve folding. Users can control the system by the control switch 209 or remotely control the drive module 204 to achieve automatic opening and closing.

Specifically, the drive module 204 outputs a square wave voltage to control the rotation of the first motor 21 and the second motor 31. The first reduction gearbox 22 and the second reduction gearbox 32 perform primary reduction, while the first gear transmission mechanism 41 and the second gear transmission mechanism 5 perform secondary reduction. The first gear transmission mechanism 41 and the second gear transmission mechanism 5 respectively drive the first swing arm 64 and the second swing arm 65 to swing, thereby achieving automatic opening and closing of the first main body 201 and the second main body 202. The power supply module 205 supplies power to the deformation monitoring plate 12 and detects deformation of the screen 203 through changes in resistance. When the resistance exceeds a certain threshold, the DC voltage is controlled to input to cause the motor to heat up, thereby achieving a crease repair function of the folding screen.

In this embodiment, the electronic device 200 further includes a first support plate 206, a second support plate 207, and a third support plate 208 arranged in parallel. The first support plate 206, the second support plate 207, and the third support plate 208 are mounted on the first hinge mechanism 6. The first support plate 206, the second support plate 207, and the third support plate 208 are all located below the screen 203. The second support plate 207 is located below the fold region 2031. The first support plate 206 and the third support plate 208 fold or unfold synchronously with the first hinge mechanism 6, and the deformation monitoring plate 12 is located between the fold region 2031 and the second support plate 207. The first support plate 206, the second support plate 207, and the third support plate 208 may also be flexible printed circuit (FPC) boards, which are convenient for installation and electrical connectivity.

In this embodiment, a side of the second support plate 207 adjacent to the screen 203 is recessed toward the side away from the screen 203 to form a clearance region 2071, and the deformation monitoring plate 12 is located within the clearance region 2071. This facilitates the installation and positioning of the deformation monitoring plate 12.

Compared with the related art, in the electric hinge apparatus of the present application, the first drive mechanism and the second drive mechanism are relatively mounted on the base, and the first drive mechanism includes a first motor fixed to the base and a first reduction gearbox fixed to the base and connected to the first motor. The second drive mechanism is arranged side by side with the first drive mechanism, and the second drive mechanism includes a second motor fixed to the base and a second reduction gearbox fixed to the base and connected to the second motor. The first gear transmission mechanism and the second gear transmission mechanism are respectively connected to an output end of the first reduction gearbox of the first drive mechanism and an output end of the second reduction gearbox of the second drive mechanism for power transmission, and the first gear transmission mechanism and the second gear transmission mechanism are coupled together to form synchronous transmission. This multi-stage transmission method, which combines reduction gearboxes and gear transmission mechanisms, provides sufficient torque for the foldable smartphone. While the dual motors drive in parallel, the dual output shafts are coupled via a gear set, enabling synchronized opening and closing on both sides, thereby delivering an intelligent and technologically advanced user experience. Additionally, by connecting the first gear transmission mechanism and the second gear transmission mechanism to the first hinge mechanism for power transmission, the first hinge mechanism is driven to achieve automatic synchronized folding or unfolding. When the screen is in the unfolded state, the deformation monitoring plate monitors whether a crease exists in the fold region of the screen. If the crease is detected in the fold region, the resistance value of the deformation monitoring plate changes. When the resistance value of the deformation monitoring plate exceeds the preset threshold resistance, the input voltage to the first motor and second motor is set to a DC voltage, causing the first motor and second motor to generate heat and warm the fold region of the screen. This induces minor changes in the molecular structure of the screen material at that location, thereby reducing or eliminating the crease and enhancing the user experience.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. An electric hinge apparatus for adjusting automatic opening and closing of a screen, wherein the screen comprises a fold region, and the electric hinge apparatus comprises:
a base;
a first drive mechanism, comprising:
a first motor fixed to the base; and
a first reduction gearbox fixed to the base and connected to the first motor for power transmission;
a second drive mechanism arranged in parallel with the first drive mechanism, and comprising:
a second motor fixed to the base; and
a second reduction gearbox fixed to the base and connected to the second motor for power transmission, wherein the fold region is located on a side of the first motor and a side of the second motor that are away from the base;
a first gear transmission mechanism connected to an output end of the first reduction gearbox of the first drive mechanism;
a second gear transmission mechanism connected to an output end of the second reduction gearbox of the second drive mechanism, wherein the first gear transmission mechanism and the second gear transmission mechanism are coupled to form synchronous transmission;
a first hinge mechanism mounted on the base, wherein the first gear transmission mechanism and the second gear transmission mechanism are connected to the first hinge mechanism for power transmission, so as to drive the first hinge mechanism to achieve synchronous folding or unfolding; and
a deformation monitoring plate fixedly attached to a side of the fold region adjacent to the first motor and the second motor, wherein the deformation monitoring plate is configured to monitor whether a crease exists in the fold region of the screen when the screen is in an unfolded state; a resistance value of the deformation monitoring plate changes if the crease exists in the fold region; when the resistance value of the deformation monitoring plate exceeds a predetermined threshold resistance, an input voltage to the first motor and an input voltage to the second motor are controlled to be a DC voltage, causing the first motor and the second motor to generate heat to warm the fold region of the screen.

2. The electric hinge apparatus of claim 1, further comprising a bracket fixed to the base, wherein the first reduction gearbox and the second reduction gearbox are fixed to the bracket.

3. The electric hinge apparatus of claim 1, wherein the first gear transmission mechanism comprises a first gear, a second gear meshed with the first gear, a third gear coaxially driven with the second gear, a fourth gear meshed with the third gear, and a first output shaft fixed to an end of the fourth gear away from the first motor and connected to the first hinge mechanism;
the second gear transmission mechanism comprises a fifth gear, a sixth gear meshed with the fifth gear, a seventh gear coaxially driven with the sixth gear, an eighth gear meshed with the seventh gear, and a second output shaft fixed to an end of the eighth gear away from the first motor and connected to the first hinge mechanism, wherein the second gear is coupled to the sixth gear.

4. The electric hinge apparatus of claim 3, wherein a diameter of the first gear is equal to a diameter of the third gear, a diameter of the second gear is equal to a diameter of the fourth gear, and the diameter of the second gear is greater than the diameter of the first gear;
the diameter of the first gear is equal to a diameter of the fifth gear, and the diameter of the second gear is equal to a diameter of the sixth gear; the diameter of the third gear is equal to a diameter of the seventh gear, and the diameter of the fourth gear is equal to a diameter of the eighth gear.

5. The electric hinge apparatus of claim 4, further comprising a fixing plate, which is fixed to the base and disposed between the first gear and the third gear and between the fifth gear and the seventh gear, wherein the first gear to the eighth gear are respectively rotatably connected to the fixing plate.

6. The electric hinge apparatus of claim 5, further comprising a fixing member having an arc-shaped surface, which is fixed to the base; wherein the fixing plate is inserted and fixed to the fixing member, and the first gear, the second gear, the fifth gear, and the sixth gear are respectively rotatably disposed on the arc-shaped surface.

7. The electric hinge apparatus of claim 1, wherein the first reduction gearbox and the second reduction gearbox are both three-stage planetary reduction gearboxes.

8. The electric hinge apparatus of claim 3, wherein the first hinge mechanism comprises:
a first slider and a second slider, wherein the first slider and the second slider are arranged oppositely, and an end of the first slider adjacent to the second slider and an end of the second slider adjacent to the first slider are respectively connected to the first gear transmission mechanism and the second gear transmission mechanism for power transmission; the first slider is fixedly sleeved around the first output shaft, and the second slider is fixedly sleeved around the second output shaft;
a first fixing block, which is fixed to the base and located on a side of the first slider away from the first drive mechanism and a side of the second slider away from the second drive mechanism; an end of the first output shaft is rotatably connected to the first fixing block, and an end of the second output shaft is rotatably connected to the first fixing block;
a first swing arm and a second swing arm that are arranged side by side, wherein an end of the first swing arm and an end of the second swing arm that are close to each other are both rotatably connected to the first fixing block; and
a first connecting member and a second connecting member that are located on opposite sides of the first fixing block, respectively, wherein an end of the first slider away from the second slider is slidably connected to the first connecting member, and an end of the first swing arm away from the first fixing block is rotatably connected to the first connecting member; an end of the second slider away from the first slider is slidably connected to the second connecting member, and an end of the second swing arm away from the first fixing block is rotatably connected to the second connecting member.

9. The electric hinge apparatus of claim 8, wherein the first connecting member comprises a first connecting body, a first T-shaped groove formed by the first connecting body extending from a side adjacent to the first fixing block to a side away from the first fixing block, and a first arc-shaped groove; the end of the first slider away from the second slider is disposed within the first T-shaped groove and forms a sliding connection, and the end of the first swing arm away from the second swing arm is disposed within the first arc-shaped groove and forms a rotational connection;
the second connecting member comprises a second connecting body, a second T-shaped groove formed by the second connecting body extending from a side adjacent to the first fixing block to a side away from the first fixing block, and a second arc-shaped groove; the end of the second slider away from the first slider is disposed within the second T-shaped groove to form a sliding connection, and an end of the second swing arm away from the first swing arm is disposed within the second arc-shaped groove to form a rotational connection.

10. The electric hinge apparatus of claim 1, further comprising a second hinge mechanism fixed to the base and located at an end of the first drive mechanism and an end of the second drive mechanism that are away from the first hinge mechanism, wherein the second hinge mechanism is arranged opposite the first hinge mechanism, and the second hinge mechanism has the same structure as the first hinge mechanism.

11. The electric hinge apparatus of claim 1, further comprising a conductive member fixed to the base and located between the first drive mechanism and the second drive mechanism, wherein the conductive member is electrically connected to the first drive mechanism, the second drive mechanism, and the deformation monitoring plate.

12. An electronic device, comprises:
a first body;
a second body;
a control switch;
a power module;
a drive module; and
the electric hinge apparatus of claim 1;
wherein the power supply module is fixed within the first body and/or the second body, and the power supply module is configured to supply power to the drive module and the deformation monitoring plate; the screen is covered and fixed on a side of the first body, a side of the electric hinge apparatus, and a side of the second body that are away from the base; the control switch controls the drive module to operate; the first body and the second body are located on opposite sides of the base, respectively, and the first body and the second body are fixed on opposite sides of the first hinge mechanism, respectively;
the drive module is electrically connected to the first drive mechanism and the second drive mechanism, to control the first drive mechanism and the second drive mechanism to operate.

13. The electronic device of claim 12, further comprising a first support plate, a second support plate, and a third support plate that are arranged in parallel, wherein the first support plate, the second support plate, and the third support plate are mounted on the first hinge mechanism, and they are all located below the screen; the second support plate is located below the fold region; the first support plate and the third support plate fold or unfold synchronously with the first hinge mechanism, and the deformation monitoring plate is located between the fold region and the second support plate.

14. The electronic device of claim 13, wherein a side of the second support plate adjacent to the screen is recessed toward a side away from the screen to form a clearance region, and the deformation monitoring plate is located within the clearance region.
